(19) United States
(12) Patent Application Publication
(10) Pub. No.: US 2007/0109145 A1
(43) Pub. Date: May 17, 2007

(54) Lighted display device with user selectable message

(76) Inventor: Chi-Li Tang, Dearborn Heights, MI (US)

Correspondence Address: The Weintraub Group, P.L.C., Suite 240, 32000 Northwestern Highway, Farmington Hills, MI, 48334, US

(21) Appl. No.: 11/589,568

(22) Filed: Oct. 30, 2006

Related U.S. Application Data
(60) Provisional application No. 60/731,765, filed on Oct. 31, 2005.

(51) Int. Cl. G09F 9/33

(52) U.S. Cl. 340/815.45

(57) ABSTRACT

The present invention relates to a lighted display device for attachment to a motor vehicle. A first light emitting diode array and a second light emitting diode array are mounted on the display side of the frame. A user may select a first message to be displayed on the first light emitting diode array and a second message to be displayed on the second light emitting diode array. The device may be attached directly to the license plate of a vehicle or directly to the vehicle. In one embodiment, the device is attached to a vehicle hitchsocket.

### CROSS-REFERENCE TO RELATED APPLICATION

This application claims the benefit of co-pending U.S. Provisional Application Ser. No. 60/731,765, filed on Oct. 31, 2005, the entire disclosure of which incorporated herein by reference.

### FIELD OF THE INVENTION

The present invention relates to a lighted display device attachable to a motor vehicle. More specifically, the invention relates to a lighted display device having a user selectable message.

### BACKGROUND OF THE INVENTION

The art is replete with lighted display devices for motor vehicles. Among the devices known in the art are decorative lights formed of light pipes and adapted to be installed beneath the vehicle. Apart from decorative lighting are safety lights such as the well known brake light or turn signal, which acts a message to motor vehicle operators that the vehicle is slowing or turning.

Apart from basic traffic signals, there is a need to warn other operators of non-traffic related emergencies. For example, in the event the operator becomes suddenly ill, such as a heart attack, there is a need to communicate this to other motor vehicle operators who otherwise would not be aware of a life threatening condition. A 911 call on a mobile phone may not result in a timely dispatch. By notifying others that a serious situation is at hand, a life may be saved.

The art includes basic illuminating warning devices, however these devices do not meet all situations. A static “HELP” message may only result in peril for an unknowing rescuer, as the emergency may be criminal in nature. Therefore, there is a need in the art for a user selectable message to others.

Additionally, the message needs to be sufficiently large in size to be visible. In the event several words are required to express the message of the user, a single light signal display may be insufficient.

Finally, a warning or message device should be adapted to be operated remotely, with a wireless transmitter to assure the device is as flexible as it can be for the user.

Thus, it is desirable to provide a lighted display device attachable to a motor vehicle that permits a user to select a message to be displayed. Furthermore, it is desirous to provide a lighted display frame that has multiple displays. And finally, a display device that may be activated remotely and/or wirelessly is further desirous.

### SUMMARY OF THE INVENTION

A lighted display device for attachment to a motor vehicle comprises a frame having a display side and a mounting side. In a first embodiment hereof at least a first light emitting diode array and a second light emitting diode array are mounted on the display side of the frame. A circuit board is attached to the frame. An electrical circuit is disposed upon said circuit board for providing user selectable output signals to both of the first light emitting diode array and the second light emitting diode array, whereby a user may select a first message to be displayed on the first light emitting diode array and a second message to be displayed on the second light emitting diode array. The output signal may be controlled by a CPU. This embodiment is deployed in connection with a license plate frame and has a license plate removably secured thereto.

In a second embodiment hereof, the display, preferably, includes a third array and is mounted to a frame including a seat and which is removably secured to a vehicular trailer hitch.

Additionally, a user may select the message(s) to be displayed from a wireless device. In one embodiment, the wireless device is a key fob.

Further objects, features and advantages of the present invention will become apparent to those skilled in the art from analysis of the following written description, the accompanying drawings and the appended claims.

### BRIEF DESCRIPTION OF THE DRAWINGS

FIG. 1 is a plan view of a first embodiment of a lighted display device according to the principles of the present invention;

FIG. 1A is a perspective view of a first embodiment of a frame having a lighted display device hereof and adapted to receive a vehicular license plate;

FIG. 2 is a plan view of a second embodiment of a lighted display device according to the principles of the present invention;

FIG. 3 is a perspective view of the lighted display device of FIG. 2, adapted to be secured into a vehicle trailer hitch socket;

FIG. 3A is an exploded perspective view showing the light array being mounted to an assembly for attachment to a vehicle hitch socket;

FIG. 4 is an exemplary schematic diagram of the light emitting diode array circuit of the lighted display device of FIG. 2, and

FIG. 5 is an exemplary schematic diagram of the light emitting diode array and control circuit of the first embodiment hereof.

### DESCRIPTION OF THE PREFERRED EMBODIMENT

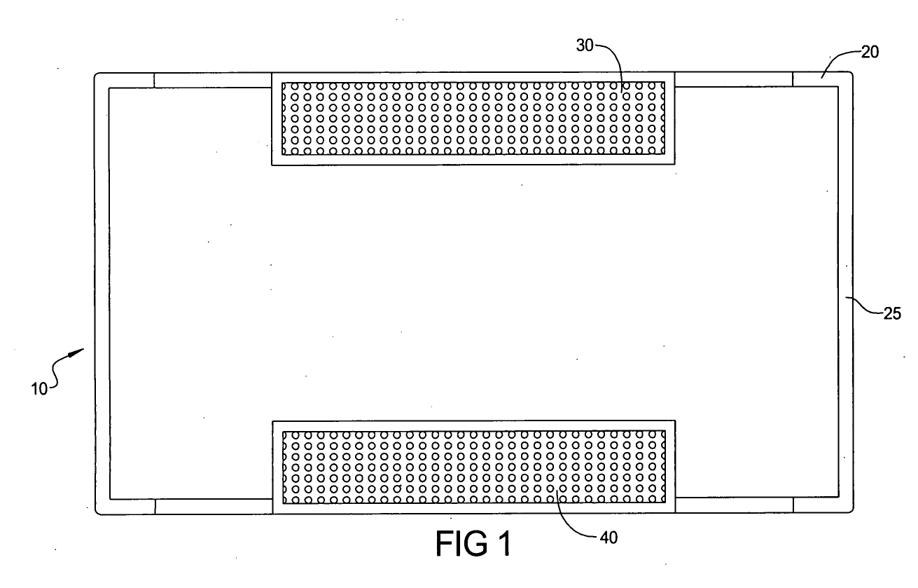

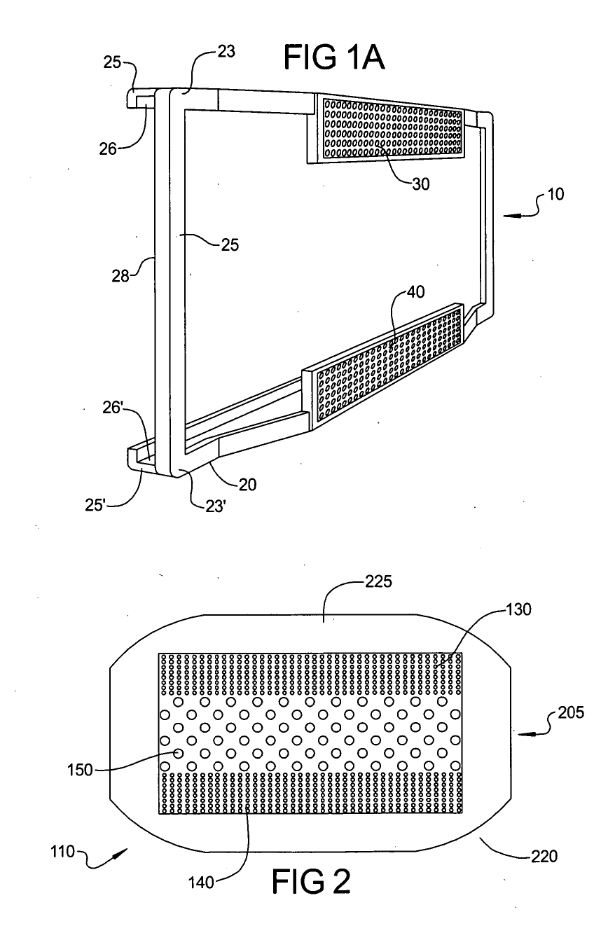

Referring now to FIGS. 1 and 1A, there is shown a first embodiment of a lighted display device 10 according to the principles of the present invention. The display device 10 is provided for attachment to a motor vehicle, and comprises a frame 20 having a display side 25 and a mounting side 28. A first light emitting diode array 30 and a second light emitting diode array 40 are mounted on the display side 28 of the frame 20 I spaced apart relationship.

The frame 20 is adapted to be disposed about the periphery of a vehicular license plate, by any suitable means. For example, a suitable adhesive may be used to adhere the frame to a license plate. Alternate mounting means may include fasteners which project through the frame and a license plate to secure the frame thereto as well as claw-like fingers formed on the frame and which engage suitable receptor apertures provided in the license plate.

Similarly, and as shown in FIGS. 1 and 1A, that the frame 20 comprises opposed top wall 23 and bottom wall 23′. An L-shaped channel member 25 is integrally formed with and projects laterally outwardly from the mounting side 28 of the frame 20 proximate top wall 23. A similar channel member 25′ projects outwardly from bottom wall 23′. The opposed channels 26, 26′ defined by channel members 25 and 25′ cooperate to define a track into which a license plate may be slideably disposed. End caps (not drawn) may be used to seal off the track. It is to be understood that the track may be formed in the sidewalls 28, 28′ Of the frame 20 by forming the channel members thereon.

The frame 20, per se, may be formed from any suitable material such as plastic, aluminum or other light weight material.

Although not shown, a circuit board associated with each array is attached to the frame 20 on the mounting array 30 and 40. The device 10 is powered by any suitable means including a battery or may be wired into the vehicular power system by any suitable means known to the skilled artisan.

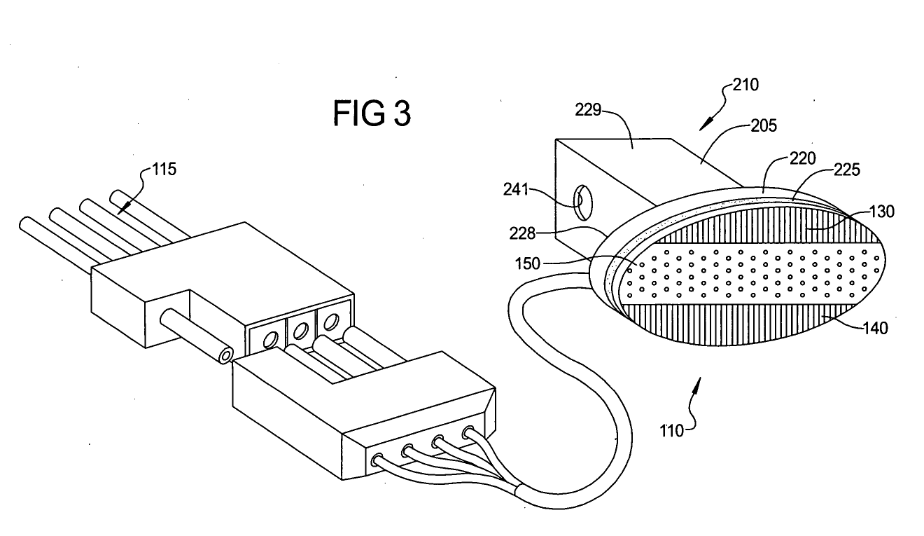

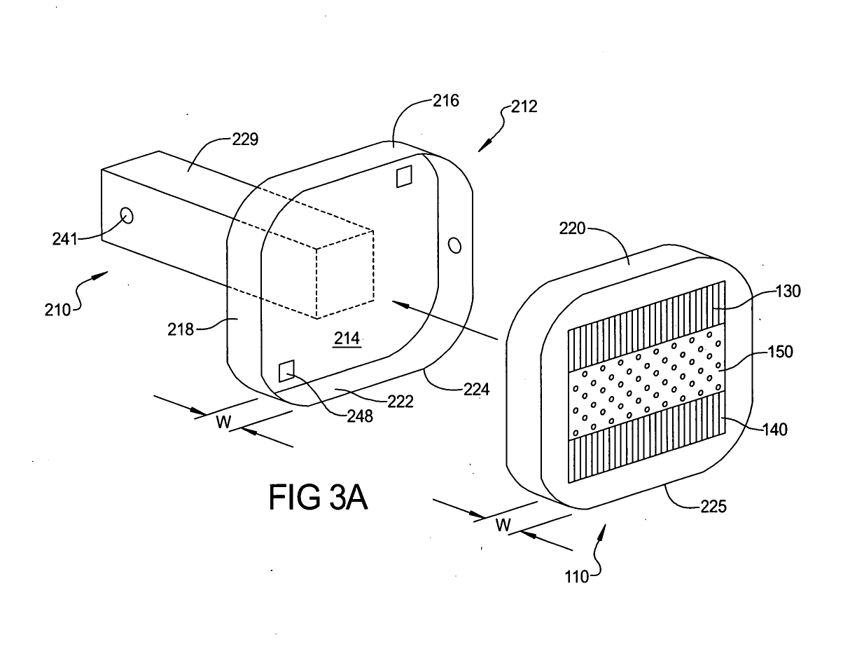

Referring now also to FIGS. 2, 3 and 3A there is shown a plan view of a second embodiment of a lighted display device 110 according to the principles of the present invention. A frame 220 supports a first light emitting diode array 130 and a second light emitting diode array 140. At least one additional array 150 may also be mounted onto the frame 120.

The device 110 is adapted to be secured into a vehicle trailer hitch socket (not shown). In accordance with the embodiment, the device 110 hereof is shown in association with a standard 4 way flat end connector 115 powered by the vehicle power system (not shown).

The display device 110 includes a hitch cover lamp unit 205 having supported by the frame 220. The frame 220 supports at least a first and second light emitting diode array 130, 140, respectively, and, preferably, a third array 150, on a display side 225 of the frame 220. The frame 220, also, includes an opposite mounting side 228.

According to this embodiment, the device 110 is mounted to a hitch socket mounting assembly 210. The mounting assembly 210 includes a seat 212 which is dimensioned to seat the device 110 therewithin.

The seat 212 includes a bottom wall 214 and, perimetral integrally formed side walls 216, 218, 222 and 224 extending outwardly and normally from the seat 212, as shown, and which cooperate to define a curvilinear sidewall. The walls 216, 218, 222 and 224 have a height equal to the width of the frame 220, to enable a flush seating for the device 110 within the seat 212.

As shown, a post 229 extends outwardly from the bottom wall 214 of the seat 212. The post 229 is dimensioned to be insertable into the interior of a standard vehicular hitch socket and is removably affixed therewithin via suitable means such as a bolt (not shown) insertable through a mounting aperture 241. The mounting of the assembly 210 to a vehicular hitch is well known to the skilled artesian. In the present embodiment, a plurality of electrical conductors 260 extend from the device 110, through the frame 220, and exit from the seat via aperture 242 and are, then, electrically coupled to the connector 115 to provide electrical power, from the motor vehicle to the light emitting diode arrays 130, 140 and 150.

A cover may be disposed over the display side 225 to protect the device from inclement weather conditions.

Although the device 110 is depicted as ovular, it is to be understood that other configurations, such as rectangular, triangular and the like may be used herein.

Although vehicle power is shown, those skilled in the art will immediately recognize that any suitable power source may be substituted for vehicle power, including, for example, battery, solar, fuel cell and the like.

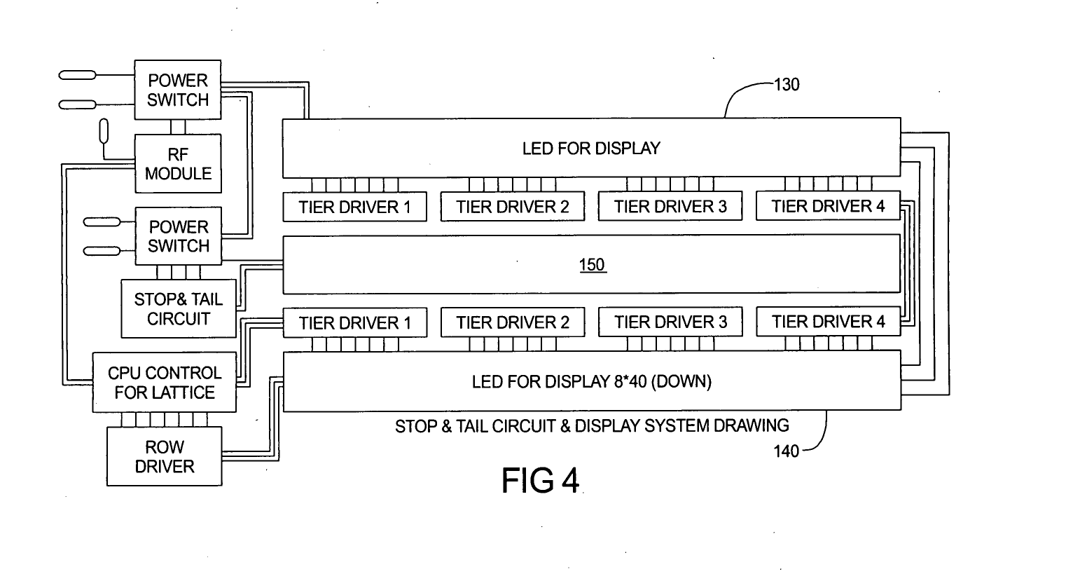

Referring now also to FIG. 4, an exemplary schematic diagram of the light emitting diode array circuit of the lighted display device of FIG. 2 is shown. A CPU 165 is employed to control the flow of output signals to the light emitting diode arrays 130, 140 and 150.

The CPU may be stored within a frame 220 or in the seat as at 243 and electrically coupled to the arrays. Although a CPU 165 is disclosed, it should become apparent to those skilled in the art that any suitable substitute known in the art, such as a resistor/capacitor timer or an op amp may be substituted for the CPU 165.

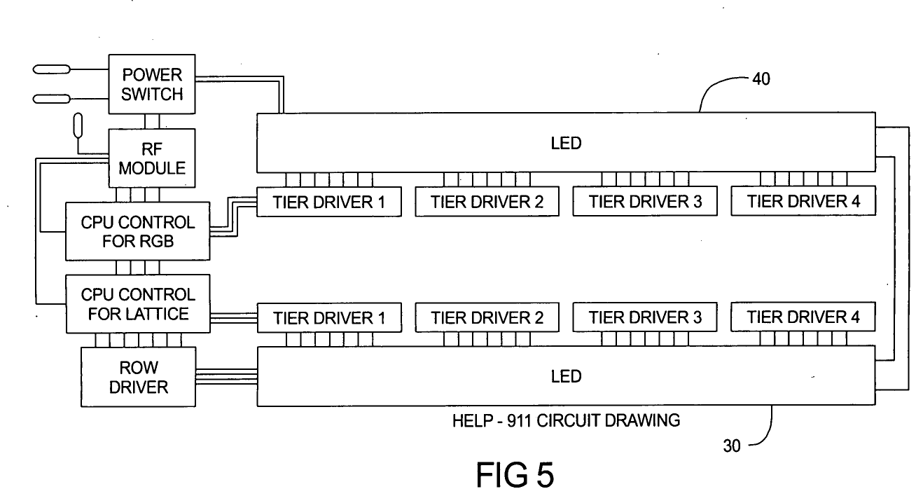

Referring now also to FIG. 5, an exemplary schematic diagram of the embodiment of FIG. 1, revealing light emitting diode arrays 30, 40 and control circuit 60 according to the principles of the present invention is shown. The electrical circuit 60 is disposed upon the circuit board (not shown) for providing user selectable output signals to both of the first light emitting diode array 30 and the second light emitting diode array 40, whereby a user may select a first message to be displayed on the first light emitting diode array 30 and a second message to be displayed on the second light emitting diode array 40. In the present example, the circuit 60 includes an FR Module 61 for receiving wireless signals from a user and an HT658 decoder for interpreting the received signals. As such, in the preferred embodiment, the device 10 may receive a command from a user by a wireless device (not shown). A transmitting device (not shown) may be disposed in a key fob, for example. As such, a user may select pre-programmed messages to be displayed on either or both of the first light emitting diode array 30 and the second light emitting diode array 40. In displaying the present device, each light array may not be pre-programmed to independently transmit a message such as “Help”; “911” or simply intermittently emit a light signal. Furthermore, the pre-programmed CPU may be changed or altered to change the message or signal.

Thus, the present invention provides means for visually displaying a distress signal, warning or other message. Because of the intensity of the LEDs within each array, the message or signal may be viewed from a distance remote from the vehicle as well as activated remote from the vehicle. The remote device, such as a key fob (not shown), may be used to select the message to be displayed.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention as defined in the following claims.

1. A lighted display device, comprising:
a frame, the frame having a display side and a mounting side;
a first light emitting diode array disposed on the frame, on the display side;
a second light emitting diode array disposed on the display side of the frame in spaced relationship from the first array;
means for displaying a first message on the first array; and
means for displaying a second message on the second array.

2. The device of claim 1 which further comprise:
means for powering the device.

3. The device of claim 1 which further comprises:
A control circuit, the control circuit enabling user selectable output signals for both the first and second diode arrays.

4. The device of claim 3 wherein:
the electrical circuit includes:
(a) means for receiving a wireless signal, and
(b) means for decoding and interpreting the received signal.

5. The device of claim 1 wherein:
each of the first and second light emitting diode arrays include preprogrammed messages.

6. The device of claim 1 which further comprises:
means for associating a vehicular license plate with the frame.

7. The device of claim 6 wherein:
The frame includes means for fastening the frame to a vehicular license plate to thereby associate the frame and the plate.

8. The device of claim 1 which further comprises:
means for mounting the frame to a vehicular trailer hitch.

9. The device of claim 8 which further comprises:
a third light emitting diode array disposed intermediate the first and second arrays.

10. The device of claim 8 wherein:
the frame comprises a post extending outwardly from the frame,
the post being insertable into a socket of the hitch to secure the device to the hitch.

11. The device of claim 8 which further comprises:
means for electrically connecting the device to a vehicular powering four way flat-end connector.

12. The device of claim 8 which further comprises:
A CPU associated with each array for controlling the output of the associated array.

13. The device of claim 8 which further comprises;
a cover for the device.

14. The device of claim 1 which further comprises:
a CPU associated with each array for controlling the output of the associated array.
